(19) United States
(12) Patent Application Publication
(10) Pub. No.: US 2010/0098616 A1
(43) Pub. Date: Apr. 22, 2010

(54) CATALYST AND PROCESS FOR PREPARING CHLORINE BY GAS PHASE OXIDATION

(75) Inventors: Aurel Wolf, Wulfrath (DE); Leslaw Mleczko, Dormagen (DE); Oliver Felix-Karl Schlüter, Leverkusen (DE); Stephan Schubert, Baytown, TX (US)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/580,539

(22) Filed: Oct. 16, 2009

(30) Foreign Application Priority Data
Oct. 17, 2008 (DE) 102008052012.8

(51) Int. Cl. C01B 7/04; B01J 27/12; B01J 27/138

(52) U.S. Cl. 423/502; 502/226

(57) ABSTRACT

Catalyst compositions comprising a support material and a catalytically active material, wherein the support material comprises magnesium fluoride, and wherein the catalytically active material comprises a ruthenium-containing compound; and processes for preparing chlorine by catalytic gas phase oxidation of hydrogen chloride with oxygen, in which the catalyst comprises magnesium fluoride and at least one ruthenium compound.

### BACKGROUND OF THE INVENTION

The process of catalytic hydrogen chloride oxidation with oxygen in an exothermic equilibrium reaction, which was developed by Deacon in 1868, was the start of industrial chlorine chemistry:

4 HCl+O₂ [symbol] 2Cl₂+2H₂O.

However, chloralkali electrolysis forced the Deacon process very much onto the sidelines. Almost the entire production of chlorine was accomplished by electrolysis of aqueous sodium chloride solutions [Ullmann Encyclopedia of industrial chemistry, seventh release, 2006]. However, the attractiveness of the Deacon process has increased again in recent times, since the global chlorine demand is growing more rapidly than the demand for sodium hydroxide solution. This development is very favorable to the process for preparing chlorine by oxidizing hydrogen chloride, which is decoupled from the production of sodium hydroxide solution. Furthermore, hydrogen chloride is obtained as a coproduct in large amounts, for example in phosgenation reactions, for instance in isocyanate preparation.

The oxidation of hydrogen chloride to chlorine is an equilibrium reaction. The equilibrium position shifts away from the desired end product with increasing temperature. It is therefore advantageous to use catalysts with maximum activity, which allow the reaction to proceed at low temperature.

As the current state of the art, ruthenium-based catalysts are used for HCl oxidation. The first catalysts for hydrogen chloride oxidation with the catalytically active component of ruthenium were described as early as 1965 in DE 1 567 788, in this case proceeding from RuCl₃, for example supported on silicon dioxide and aluminum oxide. Further Ru-based catalysts with the active material of ruthenium oxide or mixed ruthenium oxide and, as the support material, various oxides, for example titanium dioxide, zirconium dioxide, etc., were described in DE-A 197 48 299, DE-A 197 34 412 and EP 0 936 184 A2. In addition, documents WO 2007/134772 A1 and WO 2007/134721 A1 disclose ruthenium-based catalyst systems comprising tin dioxide. The oxidic supports have the disadvantage that they can react with the hydrogen chloride present in the reaction to form volatile metal halides. It is thus possible for both the activity and the mechanical stability of the catalyst to be adversely affected,

A further high-activity Ru-based catalyst system is described in WO 2007/134722 A1. In this application, the catalytically active Ru component is applied to a carbon support, specifically carbon nanotubes. The disadvantage of this system lies in the possible reaction of the support with the oxygen required for the hydrogen chloride oxidation at relatively high reaction temperature.

The Ru catalysts developed to date with oxidic or carbon-based supports possess a stability which is insufficient under the typical reaction conditions. Accordingly, Ru-based catalytic systems which are not based on oxidic or on carbon-based supports and simultaneously have a high activity and stability would be advantageous.

### BRIEF SUMMARY OF THE INVENTION

The present invention relates, in general, to processes for preparing chlorine by catalytic gas phase oxidation of hydrogen chloride with oxygen, in which the catalyst comprises a magnesium fluoride and at least one halogen- and/or oxygen-containing ruthenium compound, to a catalyst composition and to the use thereof.

Various embodiments of the present invention provide a catalytic system which is not based on oxidic or carbon-containing support materials and accomplishes the oxidation of hydrogen chloride at low temperature and with high activity. Such advantages can be achieved by employing the inventive and specific combinations of catalytically active components and support material as embodied by the present invention.

It has been found that, surprisingly, the controlled supporting of a ruthenium-containing compound on magnesium fluoride, likely owing to a particular unforeseeable interaction between catalytically active component and support, provides novel high-activity catalysts which still have a high catalytic activity especially at temperatures of ≦400° C. in hydrogen chloride oxidation.

The invention provides a catalyst composition which comprises at least magnesium fluoride as a support material and at least one ruthenium-containing compound as a catalytically active material.

One embodiment of the present invention includes a catalyst composition comprising a support material and a catalytically active material, wherein the support material comprises magnesium fluoride, and wherein the catalytically active material comprises a ruthenium-containing compound.

The invention further also provides a process for preparing chlorine by catalytic gas phase oxidation of hydrogen chloride with oxygen, in which the catalyst comprises at least magnesium fluoride and a ruthenium compound.

Another embodiment of the present invention includes a process comprising: providing a gas phase comprising hydrogen chloride and oxygen; and oxidizing the hydrogen chloride with the oxygen in the presence of a solid catalyst to form chlorine, wherein the solid catalyst comprises a catalyst composition according to the present invention.

Yet another embodiment of the present invention includes process comprising: providing a gas phase comprising hydrogen chloride and oxygen; and oxidizing the hydrogen chloride with the oxygen in the presence of a solid catalyst to form chlorine, wherein the solid catalyst comprises a catalyst support material comprising magnesium fluoride.

In various particularly preferred embodiments, magnesium fluoride used as the support of the catalytically active component comprises magnesium fluoride in rutile structure.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a ruthenium-containing compound” herein or in the appended claims can refer to a single ruthenium-containing compound or more than one ruthenium-containing compound. Additionally, all numerical values, unless otherwise specifically noted, are understood to be modified by the word “about.”

According to the invention, the catalytically active component used is at least one ruthenium-containing compound. This is especially a ruthenium halide, ruthenium hydroxide, ruthenium oxide, ruthenium oxyhalide and/or ruthenium in metallic form.

Preference is given to a catalyst composition in which the ruthenium compound is a halogen- and/or oxygen-containing ruthenium compound.

The catalytically active component used is preferably a halogen-containing ruthenium compound. This is, for example, a compound in which halogen is bonded to a ruthenium atom by an ionic to polarized covalent bond.

The halogen in the preferred halogen-containing ruthenium compound is preferably selected from the group consisting of chlorine, bromine and iodine. Particular preference is given to chlorine.

The halogen-containing ruthenium compound includes those which consist exclusively of halogen and ruthenium. Preference is given, however, to those which contain both oxygen and halogen, especially chlorine or chloride. Particular preference is given to a catalyst composition in which the catalytically active ruthenium compound is selected from the group of: ruthenium chloride, ruthenium oxychloride and a mixture of ruthenium chloride and ruthenium oxide, and especially a ruthenium oxychloride compound.

Particular preference is given to using, as the catalytically active species, at least one ruthenium oxychloride compound. A ruthenium oxychloride compound in the context of the invention is a compound in which both oxygen and chlorine are present bonded to ruthenium by an ionic to polarized covalent bond. Such a compound thus has the general composition RuOₓCl_{y}. Preferably, different ruthenium oxychloride compounds of this kind may be present alongside one another in the catalyst. Examples of defined particularly preferred ruthenium oxychloride compounds include especially the following compositions: Ru₂Cl₄,RuOCl₂, Ru₂OCl₅ and Ru₂OCl₆.

In a particularly preferred process, the halogen-containing ruthenium compound is a mixed compound corresponding to the general formula RuClₓO_{y} in which x is from 0.8 to 1.5 and y is from 0.7 to 1.6.

The catalytically active ruthenium oxychloride compound in the context of the invention is preferably obtainable by a process which comprises first the application of an especially aqueous solution or suspension of at least one halogen-containing ruthenium compound to magnesium fluoride, and the removal of the solvent.

Other conceivable processes include the chlorination of nonchlorinated ruthenium compounds, such as ruthenium hydroxides, before or after the application of the ruthenium compound to the support.

A preferred process includes the application of an aqueous solution of RuCl₃ to the magnesium fluoride.

The application of the ruthenium compound is generally followed by a drying step, which is appropriately effected in the presence of oxygen or air, in order to enable, at least in part, a conversion to the preferred ruthenium oxychloride compounds. In order to prevent a conversion of the preferred ruthenium oxychloride compounds to ruthenium oxides, the drying should preferably be performed at less than 280° C., especially at at least 80° C., more preferably at least 100° C.

A preferred process is characterized in that the catalyst is obtainable by calcining a magnesium fluoride support laden with a halogen-containing ruthenium compound at a temperature of at least 200° C., preferably at least 240° C., more preferably at least 250° C. to 500° C., especially in an oxygen-containing atmosphere, more preferably under air.

In a particularly preferred process, the proportion of the ruthenium from the catalytically active ruthenium compound in relation to the overall catalyst composition, especially after calcination, is 0.5 to 5% by weight, preferably 1.0 to 4% by weight, more preferably 1.5 to 3% by weight.

When the intention is to apply, as the catalytically active species, halogen-ruthenium compounds which do not contain any oxygen, it is also possible to dry with exclusion of oxygen at higher temperatures.

The catalyst is preferably obtainable by a process which comprises the application of an aqueous solution or suspension of at least one halogen-containing ruthenium compound to magnesium fluoride, and subsequent drying at less than 280° C., and subsequent activation under the conditions of the gas phase oxidation of hydrogen chloride, in the course of which substantial conversion to the ruthenium oxychlorides takes place. The longer the drying is effected in the presence of oxygen, the more oxychloride is formed.

In a particularly preferred variant, an oxygen-containing ruthenium compound is applied to the support. This is a compound in which oxygen is bonded to a ruthenium atom by an ionic to polarized covalent bond. This compound is prepared by the application of an aqueous solution or suspension of at least one halide-containing ruthenium compound to magnesium fluoride and subsequent precipitation by means of an alkaline compound to give ruthenium hydroxide and optionally calcination of the precipitated product.

The precipitation can be performed under alkaline conditions with direct formation of the oxygen-containing ruthenium compound. It can also be effected under reducing conditions with primary formation of metallic ruthenium, which is then calcined with supply of oxygen to form the oxygen-containing ruthenium compound.

A preferred process includes application by impregnation, etc., of an aqueous solution of RuCl₃ onto the magnesium fluoride.

The application of the halide-containing ruthenium compound is generally followed by a precipitation step and a drying or calcination step, which is appropriately effected in the presence of oxygen or air at temperatures of up to 650° C.

Typically, the loading of the catalytically active component, i.e. of the oxygen-containing ruthenium compound, is in the range of 0.1-80% by weight, preferably in the range of 1-50% by weight, more preferably in the range of 1-20% by weight, based on the total weight of the catalyst (catalyst component and support).

More preferably, the catalytic component, i.e. the ruthenium-containing compound, can be applied to the support by moist and wet impregnation of a support with suitable starting compounds present in solution or starting compounds in liquid or colloidal form, precipitation and coprecipitation processes, and ion exchange and gas phase coating (CVD, PVD).

The pre-treatment of the magnesium fluoride support can be effected especially by a calcination in the presence of oxygen-containing gases, especially air, for example at 250-1500° C., but very preferably at 300-1200° C.

The catalysts can be dried under standard pressure or preferably under reduced pressure, preferably at 40 to 200° C. The drying time is preferably 10 min to 6 h.

The catalysts can be calcined under oxygen or protective gas at 250 to 500° C. The calcination time is preferably 30 min to 24 h.

The inventive catalysts for hydrogen chloride oxidation are notable for a high activity at low temperatures.

Preferably, as already described above, the novel catalyst composition is used in the catalytic process known as the Deacon process. In this process, hydrogen chloride is oxidized with oxygen in an exothermic equilibrium reaction to chlorine, which forms water vapor. The reaction temperature is typically 180 to 500° C., more preferably 200 to 400° C., especially preferably 220 to 350° C.; the customary reaction pressure is 1 to 25 bar, preferably 1.2 to 20 bar, more preferably 1.5 to 17 bar, most preferably 2 to 15 bar. Since the reaction is an equilibrium reaction, it is appropriate to work at minimum temperatures at which the catalyst still has a sufficient activity. It is also appropriate to use oxygen in superstoichiometric amounts. For example, a two- to four-fold oxygen excess is typical. Since there is no risk of any selectivity losses, it may be economically advantageous to work at relatively high pressure and correspondingly at a longer residence time compared to standard pressure.

Suitable catalysts may contain, in addition to the ruthenium compound, also compounds of other metals or noble metals, for example gold, palladium, platinum, osmium, iridium, silver, copper, chromium or rhenium.

The catalytic hydrogen chloride oxidation can preferably be performed adiabatically or isothermally or virtually isothermally, batchwise but preferably continuously, as a fluidized bed or fixed bed process, preferably as a fixed bed process, more preferably in tube bundle reactors over heterogeneous catalysts at a reactor temperature of 180 to 500° C., preferably 200 to 400° C., more preferably 220 to 350° C., and a pressure of 1 to 25 bar (1000 to 25000 hPa), preferably 1.2 to 20 bar, more preferably 1.5 to 17 bar and especially preferably 2.0 to 15 bar.

Typical reaction apparatus in which the catalytic hydrogen chloride oxidation is performed is fixed bed or fluidized bed reactors. The catalytic hydrogen chloride oxidation can preferably also be performed in a plurality of stages.

In the adiabatic, isothermal or virtually isothermal process regime, but preferably in the adiabatic process regime, it is also possible to use a plurality of, especially 2 to 10, preferably 2 to 6, reactors connected in series with intermediate cooling. The hydrogen chloride can either be added completely together with the oxygen upstream of the first reactor or distributed over the different reactors. This series connection of individual reactors can also be combined in one apparatus.

A further preferred embodiment of an apparatus suitable for the process consists in using a structured catalyst bed in which the catalyst activity rises in flow direction. Such a structuring of the catalyst bed can be accomplished through different impregnation of the catalyst supports with active material or through different dilution of the catalyst with an inert material. The inert materials used may, for example, be rings, cylinders or spheres of magnesium fluoride, titanium dioxide, zirconium dioxide or mixtures thereof, aluminum oxide, steatite, ceramic, glass, graphite or stainless steel, preferably magnesium fluoride. In the case of the preferred use of shaped catalyst bodies, the inert material should preferably have similar external dimensions.

Suitable shaped catalyst bodies include shaped bodies with any desired forms, preference being given to tablets, rings, cylinders, stars, wagonwheels or spheres, particular preference being given to rings, cylinders, spheres or star extrudates, as the form. Preference is given to the spherical form. The size of the shaped catalyst bodies, for example diameter in the case of spheres or maximum cross-sectional width, is, on average, especially 0.3 to 7 mm, very preferably 0.8 to 5 mm.

Alternatively to the above-described finely divided (shaped) catalyst bodies, the support may also be a monolith of support material, for example not just a “conventional” support body with parallel channels not connected radially to one another; also included are foams, sponges or the like, with three-dimensional connections within the support body to form the monoliths, and support bodies with crossflow channels.

The monolithic support may have a honeycomb structure, or else an open or closed cross-channel structure. The monolithic support possesses a preferred cell density of 100 to 900 cpsi (cells per square inch), more preferably of 200 to 600 cpsi.

A monolith in the context of the present invention is disclosed, for example, in “Monoliths in multiphase catalytic processes—aspects and prospects”, by F. Kapteijn, J. J. Heiszwolf T. A. Nijhuis and J. A. Moulijn, Cattech 3, 1999, p. 24.

Suitable additional support materials or binders for the support are particularly, for example, silicon dioxide, graphite, titanium dioxide with rutile or anatase structure, zirconium dioxide, aluminum oxide or mixtures thereof, preferably titanium dioxide, zirconium dioxide, aluminum dioxide or mixtures thereof, more preferably γ- or δ-aluminum oxide or mixtures thereof. A preferred binder is aluminum oxide or zirconium oxide. The proportion of binder may, based on the finished catalyst, be 1 to 30% by weight, preferably 2 to 25% by weight and very preferably 5 to 20% by weight. The binder increases the mechanical stability (strength) of the shaped catalyst bodies.

In a particularly preferred variant of the invention, the catalytically active component is present essentially on the surface of the actual support material, for example of the magnesium fluoride, but not on the surface of the binder.

For additional doping of the catalysts, suitable promoters are alkali metals or metal compounds such as lithium, sodium, potassium, rubidium and cesium, preferably lithium, sodium and potassium, more preferably potassium, alkaline earth metals such as magnesium, calcium, strontium and barium, preferably magnesium and calcium, more preferably magnesium, rare earth metals such as scandium, yttrium, lanthanum, cerium, praseodymium and neodymium, preferably scandium, yttrium, lanthanum and cerium, more preferably lanthanum and cerium, or mixtures thereof.

The promoters may, without being restricted thereto, be applied to the catalyst by impregnation and CVD processes, preference being given to impregnation, for example of metal compounds, especially nitrates, and special preference being given to combined application with the catalytic main component.

The conversion of hydrogen chloride in the HCl oxidation in single pass can preferably be limited to 15 to 90%, preferably 40 to 85%, more preferably 50 to 70%. Unconverted hydrogen chloride can, after removal, be recycled partly or fully into the catalytic hydrogen chloride oxidation. The volume ratio of oxygen to hydrogen chloride at the reactor inlet is preferably 1:1 to 20:1, preferably 2:1 to 8:1, more preferably 2:1 to 5:1.

The heat of reaction of the catalytic hydrogen chloride oxidation can advantageously be utilized to raise high-pressure steam. This steam can be utilized to operate a phosgenation reactor and/or distillation columns, especially isocyanate distillation columns.

In a further step, the chlorine formed is removed. The removal step typically comprises a plurality of stages, specifically the removal and optional recycling of unconverted hydrogen chloride from the product gas stream of the catalytic hydrogen chloride oxidation, the drying of the resulting stream comprising essentially chlorine and oxygen, and the removal of chlorine from the dried stream.

Unconverted hydrogen chloride and steam formed can be removed by condensing aqueous hydrochloric acid out of the product gas stream of the hydrogen chloride oxidation by cooling. Hydrogen chloride can also be absorbed in dilute hydrochloric acid or water.

The invention further provides for the use of magnesium fluoride as a catalyst support for a catalyst in the catalytic gas phase oxidation of hydrogen chloride with oxygen.

The invention further provides for the use of the novel catalyst composition as a catalyst, especially for oxidation reactions, more preferably as a catalyst in the catalytic gas phase oxidation of hydrogen chloride with oxygen.

The invention will now be described in further detail with reference to the following non-limiting examples.

### EXAMPLES

### Example 1: (Inventive)

### Supporting of Ruthenium Chloride on Magnesium Fluoride:

In a round-bottom flask, 9.8 g of commercial MgF₂ (from Aldrich) are suspended in a solution of commercially available 0.5 g of ruthenium chloride n-hydrate in 28 ml of water, and stirred at room temperature for 180 min. The excess solution was concentrated by evaporation at 60° C. overnight. The resulting solid was subsequently calcined in an air stream at 250° C. for 16 h, which afforded a ruthenium chloride catalyst supported on magnesium fluoride. The amount of ruthenium supported corresponds to a proportion of 2% by weight.

### Example 2: (Inventive)

### Supporting of Ruthenium Chloride on Magnesium Fluoride:

30 g of magnesium fluoride pellets (manufacturer: Saint-Gobain) with an average diameter of 1.5 mm and a BET surface area of 13.1 m²/g were impregnated with a solution of 1.55 g of commercial ruthenium chloride n-hydrate in 12.29 g of H₂O. After standing for 1 h, the solid was dried in an air stream at approx. 60° C. within 5 h. Subsequently, the catalyst was calcined at 250° C. for 16 h. This gives a catalyst calculated to have 2% by weight of ruthenium.

### Example 3: (Comparative Example)

### Preparation of a Ruthenium Catalyst for use in the First Reaction Zone:

50 g of SnO₂ pellets with an average diameter of 1.9 mm, a BET surface area of 0.5 m²/g and 15% by weight of Al₂O₃ as a binder were impregnated with a solution of 2.498 g of a commercial ruthenium chloride n-hydrate (Heraeus GmbH) in 5.03 g of H₂0. After standing for 1 h, the solid was dried at 60° C. in an air stream for 4 hours. Subsequently, the catalyst was calcined at 250° C. for 16 h. This gives a catalyst calculated to have 2% by weight of ruthenium.

### Catalyst Test Example 1:

Use of the Catalyst from Example 1 in HCl Oxidation:

A gas mixture of 80 ml/min (standard conditions, STP) of hydrogen chloride and 80 ml/min (STP) of oxygen flowed through 0.2 g of the catalyst according to Example 1 in a fixed bed in a quartz reaction tube (internal diameter 10 mm) at 300° C. The quartz reaction tube was heated by an electrically heated fluidized sand bed. After 30 min, the product gas stream was passed into 16% potassium iodide solution for 15 min. The iodine formed was then back-titrated with 0.1 N standard thiosulphate solution in order to determine the amount of chlorine introduced. A chlorine formation rate of 1.48 kg_{C12}/kg_{CAT}·h was measured.

### Catalyst Test Example 2:

Use of the Catalyst from Example 2 in HCl Oxidation:

25 g of the catalyst according to Example 2 were installed together with 75 g of inert material (glass beads) in a nickel fixed bed reactor (diameter 22 mm, length 800 mm) heated with an oil bath. This afforded a fixed bed of approx. 150 mm. The fixed bed was heated by means of a heat carrier heated to 350° C. At a pressure of 4 bar, a gas mixture of 40.5 l/h (STP) of hydrogen chloride, 315 l/h (STP) of oxygen and 94.5 l/h (STP) of nitrogen flowed through the fixed bed reactor. After a defined reaction time (for example 30 min), the product gas stream was passed into 16% potassium iodide solution for 5 min. The iodine formed was then back-titrated with 0.1 N standard thiosulphate solution in order to determine the amount of chlorine introduced. The catalyst activity calculated therefrom was 1.8 kg_{C12}/kg_{CAT}·h. The analysis for magnesium in the condensate was performed by means of ICP-OES (inductively coupled plasma—optical emission spectrometry, instrument: variant Vista-PRO, method according to manufacturer's instructions), and gave values below the detection limit (<0.50 mg/l).

### Catalyst Test Example 3: (Comparative)

Use of the Catalyst from Example 3 in HCl Oxidation:

25 g of the catalyst according to Example 3 were tested analogously to catalyst test example 2. A chlorine formation rate of 1.6 kg_{C12}/kg_{CAT}·h was measured. The analysis for tin in the condensate was performed by means of ICP-OES (inductively coupled plasma—optical emission spectrometry, instrument: variant Vista-PRO, method according to manufacturer's instructions) and gave values of 2.1 mg/l.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A catalyst composition comprising a support material and a catalytically active material, wherein the support material comprises magnesium fluoride, and wherein the catalytically active material comprises a ruthenium-containing compound.

2. The catalyst composition according to claim 1, wherein the ruthenium-containing compound comprises a halogen-containing ruthenium compound, an oxygen-containing ruthenium compound, or combinations thereof.

3. The catalyst composition according to claim 1, wherein the ruthenium-containing compound comprises a halogen-containing ruthenium compound selected from the group consisting of chlorine-, bromine- and iodine-ruthenium compounds and mixtures thereof.

4. The catalyst composition according to claim 1, wherein the ruthenium-containing compound comprises a chlorine-containing ruthenium compound.

5. The catalyst composition according to claim 1, wherein the ruthenium-containing compound is selected from the group consisting of ruthenium chloride, ruthenium oxychloride and mixtures thereof.

6. The catalyst composition according to claim 1, wherein the ruthenium-containing compound comprises ruthenium oxychloride.

7. The catalyst composition according to claim 1, wherein the ruthenium-containing compound corresponds to the general formula RuClₓO_{y} wherein x represents a number of 0.8 to 1.5 and y represents a number 0.7 to 1.6.

8. The catalyst composition according to claim 1, wherein the catalyst composition is prepared by a process comprising: providing the magnesium fluoride; applying a solution or suspension of the catalytically active material in a solvent to the magnesium fluoride; and removing at least a portion of the solvent.

9. The catalyst composition according to claim 8, wherein the ruthenium-containing compound comprises a halogen-containing ruthenium compound, an oxygen-containing ruthenium compound, or combinations thereof.

10. The catalyst composition according to claim 8, wherein the ruthenium-containing compound comprises RuCl₃.

11. The catalyst composition according to claim 8, wherein removing at least a portion of the solvent comprises drying at at least 80° C.

12. The catalyst composition according to claim 1, wherein the catalyst composition is prepared by a process comprising: providing the magnesium fluoride; loading the magnesium fluoride with the catalytically active material; and calcining the loaded magnesium fluoride at a temperature of at least 200° C.

13. The catalyst composition according to claim 12, wherein the catalytically active material comprises a halogen-containing ruthenium compound.

14. The catalyst composition according to claim 13, wherein calcining is carried out at a temperature of at least 240° C. in an oxygen-containing atmosphere.

15. The catalyst composition according to claim 1, wherein the ruthenium is present in an amount of 0.5 to 5% by weight, based on the catalyst composition.

16. The catalyst composition according to claim 1, wherein at least a portion of the magnesium fluoride is present in rutile form.

17. A process comprising: providing a gas phase comprising hydrogen chloride and oxygen; and oxidizing the hydrogen chloride with the oxygen in the presence of a solid catalyst to form chlorine, wherein the solid catalyst comprises a catalyst composition according to claim 1.

18. The process according to claim 17, wherein oxidizing the hydrogen chloride with the oxygen is carried out at a temperature of 180 to 500° C.

19. The process according to claim 17, wherein oxidizing the hydrogen chloride with the oxygen is carried out at a pressure of 1 to 25 bar.

20. The process according to claim 17, wherein oxidizing the hydrogen chloride with the oxygen is carried out adiabatically.

21. A process comprising: providing a gas phase comprising hydrogen chloride and oxygen; and oxidizing the hydrogen chloride with the oxygen in the presence of a solid catalyst to form chlorine, wherein the solid catalyst comprises a catalyst support material comprising magnesium fluoride.
